(19) United States
(12) Patent Application Publication
(10) Pub. No.: US 2007/0122003 A1
(43) Pub. Date: May 31, 2007

(54) System and method for identifying a threat associated person among a crowd

(75) Inventors: Uri Dobkin, Haifa (IL); Moti Shabtai, Rosh HaAyin (IL); Igal Dvir, Rananna (IL); Ariel Zilberstein, Tzur Yigal (IL)

Correspondence Address: MERCHANT & GOULD PC, P.O. BOX 2903, MINNEAPOLIS, MN, 55402-0903, US

(73) Assignees: ELBIT SYSTEMS LTD., Haifa (IL); NICE SYSTEMS LTD., Raanana (IL)

(21) Appl. No.: 10/585,604

(22) PCT Filed: Jan. 9, 2005
(86) PCT No.: PCT/IL05/00025

§ 371 Date: Jul. 10, 2006

(30) Foreign Application Priority Data
Jan. 12, 2004 (IL) 159828

(51) Int. Cl. G06K 9/00

(52) U.S. Cl. 382/115; 340/506

(57) ABSTRACT

System for identifying a threat associated person among a crowd in a protected area, the system including an expert system network, and a supervising system coupled with the expert system network, the expert system network including a plurality of local expert systems, each of the local expert systems being associated with a respective one of a plurality of surveillance fields within the protected area, each the local expert systems being coupled with a plurality of data acquisition systems of various types, each of the data acquisition systems acquiring threat related data and marking related data respective of selected persons among the crowd within the respective surveillance field, each the local expert systems determining a respective local threat level for every one of the selected persons within the respective surveillance field, according to the threat related data and the marking related data, the supervising system coordinating the operation of the local expert systems, the supervising system receiving from each of the local expert systems the respective local threat level, for every one of the selected persons within the respective surveillance field, the supervising system determining a global threat level according to the local threat levels, thereby identifying the threat associated person.

### FIELD OF THE DISCLOSED TECHNIQUE

The disclosed technique relates to security systems in general, and to methods and systems for identifying a person intending to perform a criminal act, in particular.

### BACKGROUND OF THE DISCLOSED TECHNIQUE

Due to terrorist attacks occurring in different parts of the world, the security personnel at crowded areas, such as shopping centers, airports, and office buildings, inspect the people and their belongings, before allowing entrance to such areas. A person wishing to enter a protected area, is inspected for carrying dangerous objects and materials, such as explosives, firearms, sharp edged objects, chemical weapons, biological weapons, and the like.

Methods and systems for identifying people who carry such objects are known in the art. For example, in the check-in area of airports, the contents of suitcases are imaged by an X-ray detector. Millimeter wave (MMW) detectors are employed to detect concealed metallic objects. Nuclear based explosive detection systems, such as gamma ray detectors, are employed for detecting explosives concealed in a luggage. Video cameras acquire images of suspects to be compared to images of criminals stored in a database. Voice recognition systems and biometric systems are employed to identify a suspect terrorist.

U.S. Pat. No. 6,674,367 issued to Sweatte, and entitled “Method and System for Airport and Building Security” is directed to a method and a system for continuous monitoring, location and identification of persons and their belongings entering a building, such as an airport, for security purposes. The method operates by requiring a person entering the building to approach a check-in point or counter, at which point various positive identification means are applied to the person to ascertain her identity.

Such means can include fingerprint scanning, retinal or iris scanning, and other means of positive identification. The data collected by the identification means is entered into a database, along with other government supplied identification information that is scanned at the check-in point, to be compared and checked against various law enforcement databases. A digital photograph of the person and her belongings can also be taken at various other check points, for positive identification, once that person is inside the building.

Once an initial positive identification has been obtained, the person wishing to enter the building is given an electronic card with wireless capabilities. Her belongings, baggage in the case of airports, can also be tagged or marked with such electronic cards. The system can track the whereabouts of the cards anywhere in the building, and in the case of its use in airports, anywhere within airports and aircrafts around the world. The system can be notified whenever a person enters an area of interest, for example, when she boards a plane or enters a restricted area.

The system can also be notified if a card is abandoned or a person is carrying more than one card. The system can furthermore notify security or law enforcement personnel if an undesirable person or object has entered the building, including her or its whereabouts. More sophisticated versions of the card could also monitor when various cards are in close proximity to one another, numerous times within a building, as would be the case with a family or a group of conspiring terrorists.

U.S. Pat. No. 6,559,769 issued to Anthony et al., and entitled “Early Warning Real-Time Security System” is directed to a security system for monitoring and tracking, in real-time, the activities and movements associated with prescribed personnel, mobile vehicles, buildings, and personal property. The system also allows for preventative or immediate appropriate measures to be taken to mitigate, prevent, or stop personal injury or property damage to a given prescribed personnel, mobile vehicle, building, or object.

The system includes a plurality of hidden and conspicuous digital video cameras, as well as in situ local controllers having a microprocessor, for continuously producing digital video and audio signals of an event of interest. The signals are up-linked via a suitable wireless telecommunications device to a satellite, general packet radio service, the Internet, an intranet or extranet network, and then down-linked to a plurality of control centers where the digital video and audio signals are recorded and analyzed by trained personnel. Through analysis, the trained personnel can take or request preventative or remedial action to be taken when perturbations from normal behavior or activities are observed in the recorded video and audio signals. Up-linking of the digital video and audio signals can be on a continual basis, or can be triggered by manual intervention or predefined events. The system can be used to monitor, track, and safeguard children in a playground, a person approaching her car on a dark street late at night, passengers in an airplane, criminals and suspects in public places, and any and all conduct effectuated on a public mobile vehicle or in a public building.

U.S. Pat. No. 6,417,797 issued to Cousins, et al., and entitled “System For a Multi-Purpose Portable Imaging Device and Methods for Using Same” is directed to an imaging device capable of imaging objects, natural terrain, and people from multiple sensors. The device is small enough to be hand-held or wearable, and has at least one sensor, either active or passive, embedded on its surface. The sensor receives analog energy from an object, terrain, or person of interest and then converts the signal into digital form which is then sent to an advanced computer. The computer, built on a parallel architecture platform, can receive, process, and fuse data from multiple sensors, thereby providing sensor fusion features. The processed data is then displayed in graphical form, in real-time, on the imaging device, giving a user of the device information about an object, terrain, or person of interest.

The device has a keypad for entering data and commands, and has the capability of using read-only memory cartridges which can contain application software for manipulating sensor data in particular situations. A variety of cartridges containing numerous software applications for various situations where imaging is needed, for example, airport security, or operating rooms in hospitals, makes the device a multi-purpose device. The device can also communicate with expert systems to match generated images with stored images on a database, or compare quantitative data, such as measured dielectric constants, with their accepted values.

U.S. Pat. No. 6,359,582 issued to MacAleese, et al., and entitled “Concealed Weapons Detection System” is directed to a system and a method for detecting concealed weapons of various types, including metal and no metal weapons, utilizing radar. The system includes a transmitter for producing an output set of self-resonant frequencies for known weapons and objects that can be used as weapons or in which weapons can be hidden, for example briefcases, under clothing, belt buckles, coins, calculators, and cellular phones. The system further includes an antenna for directing the self-resonant frequencies towards locations potentially having weaponry and for receiving backscattered signals. The system further includes a receiver for receiving the backscaftered signals and operating over the range of self-resonant frequencies, as well as a signal processor for detecting and recognizing a plurality of the self-resonant frequencies in the backscattered signals.

The weapons detector system can be hand-held, mounted on a wall, or in a doorway. The system can preferably work in ranges of up to 50 yards, have a high durability, have a limited operational complexity, have a response time of less than 1 second and have a high accuracy of detection, i.e. 98%.

U.S. Pat. No. 6,127,917 issued to Tuttle, and entitled “System and Method for Locating Individuals and Equipment, Airline Reservation System, Communication System” is directed to a system and a method for locating individuals and equipment in a facility. The method works by requiring an individual to carry a portable wireless transponder device within a given facility. The portable wireless transponder device may also be attached to a piece of equipment. The facility is set up with a plurality of antennas distributed throughout the facility. The antennas are furthermore selectively separately connected to an interrogator. The interrogator, when connected to any of the antennas, has a communication range covering less than the entire area of the facility.

Individuals and equipment can be located when the system issues a command to the interrogator to repeatedly transmit a wireless command, via alternating antennas, to the portable wireless transponder device worn by or attached to the individuals and equipment of interest. The portable wireless transponder device is configured to transmit data identifying itself if the portable wireless transponder device is within the communications range of the antenna sending the command. The individuals and equipment can be located by determining which antenna the interrogator was able to establish communications with the portable wireless transponder device. The method can be used as an airline reservation system, whereby the portable wireless transponder device carried by an individual or equipment can be configured to transmit various signals when the individual or equipment enters specific areas, for example, the airport facility, a security check point, or a boarding gate. The method can be used to track the whereabouts of luggage within an airport facility, and can be used as a communications system for locating and tracking individuals and equipment.

### SUMMARY OF THE DISCLOSED TECHNIQUE

It is an object of the disclosed technique to provide a novel method and system for identifying a threat associated person in a protected area, which overcomes the disadvantages of the prior art.

In accordance with the disclosed technique, there is thus provided a system for identifying a threat associated person among a crowd in a protected area. The system includes an expert system network and a supervising system coupled with the expert system network. The expert system network includes a plurality of local expert systems, wherein each of the local expert systems is associated with a respective one of a plurality of surveillance fields within the protected area.

Each of the local expert systems is coupled with a plurality of data acquisition systems of various types. Each of the data acquisition systems acquires threat related data and marking related data respective of selected persons among the crowd within the respective surveillance field. Each of the local expert systems determines a respective local threat level for every one of the selected persons within the respective surveillance field, according to the threat related data and the marking related data.

The supervising system coordinates the operation of the local expert systems. The supervising system receives from each the local expert systems the respective local threat level, for every one of the selected persons within the respective surveillance field. The supervising system determines a global threat level according to the local threat levels, thereby identifying the threat associated person.

In accordance with another aspect of the disclosed technique, there is thus provided a method for identifying a threat associated person among a crowd. The method includes the procedures of acquiring marking related data and threat related data for at least selected persons in the crowd within a protected area, and determining a local threat level for the selected persons in each of a plurality of surveillance fields of the protected area.

The method further includes the procedure of determining a global threat level for the selected persons in the protected area, according to the local threat levels determined by the local expert systems, thereby identifying the threat associated person. Each of the local threat levels is determined by a respective one of a plurality of local expert systems, according to threat related data and marking related data acquired for the surveillance field.

### BRIEF DESCRIPTION OF THE DRAWINGS

The disclosed technique will be understood and appreciated more fully from the following detailed description taken in conjunction with the drawings in which:

FIG. 1A is a schematic illustration of a system for identifying a threatening person among a moving crowd, constructed and operative in accordance with an embodiment of the disclosed technique;

FIG. 1B is a schematic illustration of a mode of operation of one of the expert systems of the expert system network of the system of FIG. 1A, managing one of the surveillance fields of the protected area, for which the system of FIG. 1A is responsible; and

FIG. 2 is a schematic illustration of a method for operating the system of FIG. 1A, operative in accordance with another embodiment of the disclosed technique.

### DETAILED DESCRIPTION OF THE EMBODIMENTS

The disclosed technique overcomes the disadvantages of the prior art by acquiring threat related data and marking related data, respective of selected persons among a crowd in a protected area, by a plurality of data acquisition systems of various types, located in every surveillance field of the protected area. The threat related data and the marking related data are acquired from the selected persons without requiring any active cooperation by any of the selected persons, and while the selected persons continue to move in different surveillance fields of the protected area. It is noted that additional threat related data and marking related data can be acquired which do require active cooperation by the selected users.

A local expert system associated with each of the surveillance fields, determines a local threat level for the selected persons in the respective surveillance field, according to the acquired threat related data and marking related data. A supervising system determines a global threat level by assessing the local threat levels, thereby identifying a threat associated person. The supervising system, then produces a warning signal for the security personnel to arrest the threat associated person, and also provides other expert systems in adjacent surveillance fields with relevant information, to begin tracking that threat associated person.

The term “preliminary probability level” herein below, refers to the probability that a given person is about to perform a criminal act, according to the data obtained by a data acquisition system respective of that person. The term “weighed probability level” herein below, refers to a probability of a person being a suspected person, which is determined by applying a weight function respective of each of a plurality of data acquisition systems, to the respective preliminary probability level.

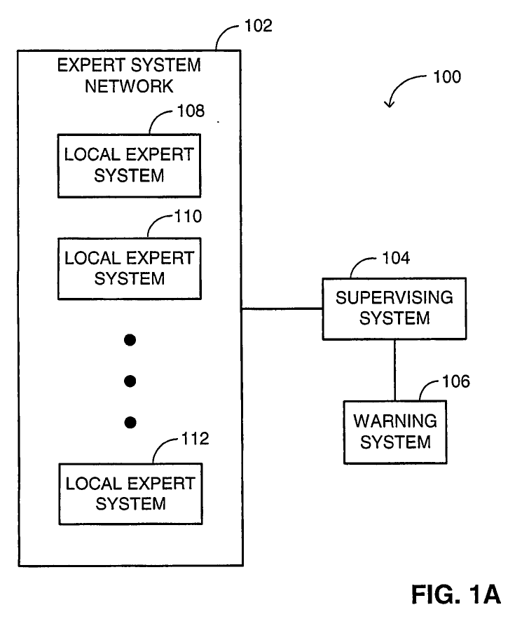

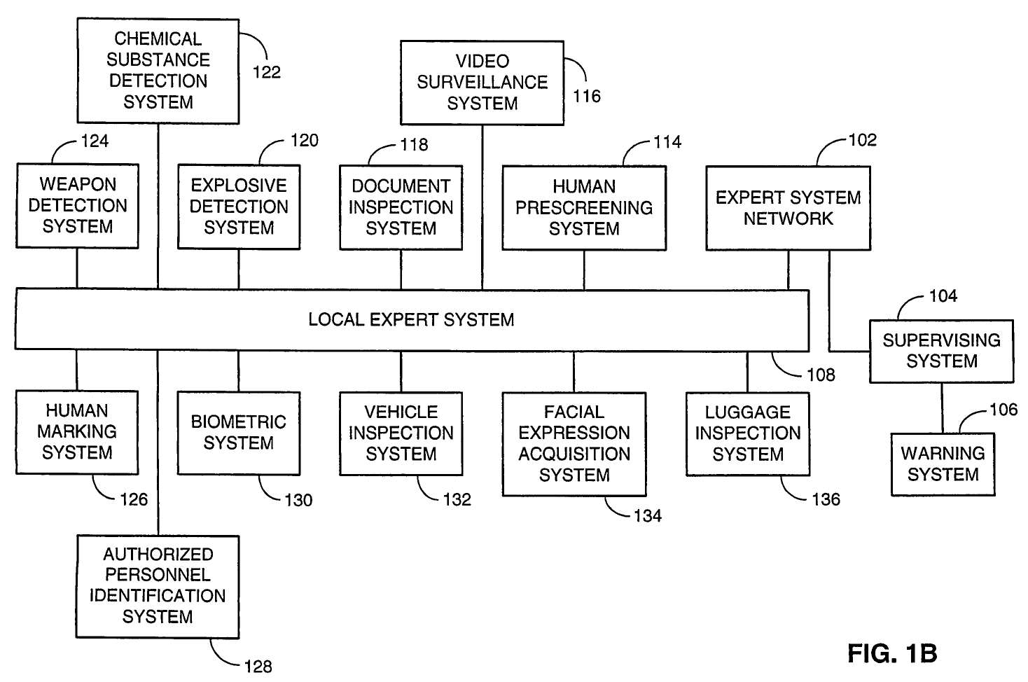

Reference is now made to FIGS. 1A and 1B. FIG. 1A is a schematic illustration of a system generally referenced 100, for identifying a threatening person among a moving crowd, constructed and operative in accordance with an embodiment of the disclosed technique. FIG. 1B is a schematic illustration of a mode of operation of one of the expert systems of the expert system network of the system of FIG. 1A, managing one of the surveillance fields of the protected area, for which the system of FIG. 1A is responsible.

With reference to FIG. 1A, system 100 includes an expert system network 102, a supervising system 104, and a warning system 106. Expert system network 102 includes a plurality of local expert systems 108, 110 and 112. Each of local expert system 108, 110 and 112 is a mainframe computer which is responsible for detecting a suspect in a given surveillance field (e.g., a terminal of an airport), and tracking a suspect which enters this surveillance field from an adjacent surveillance field. Warning system 106 is a system for producing an optic, acoustic, or tactile alarm for a human being, such as a security guard, or producing a signal for any one of local expert systems 108, 110 and 112, to track the suspect in an adjacent surveillance field. Supervising system 104 is a mainframe computer which coordinates the operation of expert system network 102 and warning system 106, and manages the operation of system 100.

Supervising system 104 is coupled with expert system network 102 and with warning system 106. Each of local expert systems 108, 110 and 112 can be coupled directly with a dedicated warning system (not shown).

With reference to FIG. 1B, local expert system 108 (which is representative of all local expert systems of expert system network 102), is coupled with a human prescreening system 114, a video surveillance system 116, a document inspection system 118, an explosive detection system 120, a chemical substance detection system 122, a weapon detection system 124, a human marking system 126, an authorized personnel identification system 128, a biometric system 130, a vehicle inspection system 132, a facial expression acquisition system 134, a luggage inspection system 136 and with expert system network 102.

In the description herein below, the term “data acquisition system” refers to any one of human prescreening system 114, video surveillance system 116, document inspection system 118, explosive detection system 120, chemical substance detection system 122, weapon detection system 124, human marking system 126, authorized personnel identification system 128, biometric system 130, vehicle inspection system 132, facial expression acquisition system 134, and luggage inspection system 136. One or more of the data acquisition systems can include a local warning system (not shown). Local expert system 108, 110 and 112, the data acquisition systems and supervising system 104, can be coupled together either by a wire or wireless link, each of which can either be electrical or optical. It is noted that the data acquisition systems are of various types, wherein some data acquisition systems provide threat related data, some provide marking related data, and some provide both.

Human prescreening system 114 is a system which includes general information about the people who are about to enter the protected area (not shown), such as computer assisted passenger prescreening system (CAPPS), and the like. In case of an airport, human prescreening system 114 includes general information about the passengers who are to board a plane, such as airline, nationality, country of origin, destination, age, sex, and the like, thereby being capable to identify a suspect, and preventing the suspect to enter the airport terminals.

Video surveillance system 116 includes a plurality of video cameras which constantly acquire images of the people in the crowd. Each of the video cameras can acquire an image either in the visible range of wavelengths or an invisible range of wavelengths. Thus, each of the video cameras can be a color video camera (e.g., charge-coupled device—CCD), gray scale video camera (e.g., black and white), thermal camera (e.g., infrared camera), and the like. Each video camera can be a pan-tilt-zoom (PTZ) camera, which can pan, tilt, or zoom-in on an image. In case of an airport, tens of such video cameras are located in each terminal, thereby forming a closed circuit television (CCTV) network.

Each video camera is provided with an illumination module (e.g., pulsed near infrared laser), a gating system and an acquisition system. The detection system determines the depth of the acquired image, and produces a three-dimensional image, according to the temporal difference between the image frames produced by the laser pulses.

Document inspection system 118 is a system for verifying the authenticity of the documents which the people in the protected area carry. In case of an airport, document inspection system 118 is a scanner which determines the authenticity of travel documents. Document inspection system 118 is capable to identify forged documents.

Explosive detection system 120 is a system for detecting explosive charges, such as plastic bomb, hand grenade, and the like, concealed behind the clothing of a person. Explosive detection system 120 can operate based on thermal neutron capture technology, and the like. Since nitrogen is found in substantially high concentrations in high explosives, the explosive charge emits gamma rays when bombarded by gamma rays, and the emitted gamma rays are detected by a gamma ray detector. Explosive detection system 120 can operate also based on picoseconds pulse laser technology, X-ray, and ultrasound.

Chemical substance detection system 122 is a system for detecting chemical substances, such as chemical warfare agent, biological agent, illicit drugs, and the like, concealed behind the clothing of a person. Chemical substance detection system 122 can operate for example, based on picoseconds pulse laser technology, X-ray, and ultrasound.

Weapon detection system 124 is a system for detecting a weapon, such as a firearm, sharp edged object, and the like, concealed behind the clothing of a person. Weapon detection system 124 can operate for example, based on millimeter wave (MMW) technology, since metals are highly reflective of surrounding temperature. Weapon detection system 124 can also operate based on infrared technology, magnetic resonance imaging (MRI), and the like.

Human marking system 126 is a system for marking persons who enter the protected area, in order to track and identify the same person in any surveillance field. For this purpose human marking system 126 includes a plurality of video cameras in each surveillance field. These video cameras take images, from different viewing angles, of each person who enters the surveillance field. The images include at least one bodily feature of the person, such as the face, musculoskeletal structure of the person, clothing thereof, and the like. Using these images, human marking system 126 produces a three-dimensional signature for that person and stores it. Whenever a person enters a surveillance field, this procedure repeats and the newly produced three-dimensional signature is compared with already stored ones, to determine whether this person is already marked.

Alternatively, the marking can be performed by attaching an integrated circuit (IC) module to the body of the person, wherein the IC module constantly transmits signals to a receiver located in the protected area, or in the vicinity thereof. Further alternatively, the marking can be in form of a bar code, an electronic tag, radioactive substances, chemical substances or biological substances.

Authorized personnel identification system 128 is a system which includes information about people which are authorized to be present in the protected area, such as security guards, maintenance staff, an airline staff at an airport, and the like, thereby enabling non-hampered transportation of the authorized personnel within the protected area. For example, in case of an airport, authorized personnel identification system 128 identifies authorized personnel which move between the terminals, according to personal identification data which they carry, such as identification tag, smart card, biometric characteristics (e.g., iris signature, fingerprint, face image, voice pattern), and the like, thereby preventing false alarm generation.

Biometric system 130 is a system which identifies criminals according to physiologic characteristics thereof, such as iris signature, fingerprint, face image, voice pattern, handwriting, and the like. Biometric system 130 identifies the criminal by comparing the physiologic characteristics of the subject, with those stored in a database (not shown).

Vehicle inspection system 132 is a system for inspecting vehicles (not shown) entering the parking lot of the protected area, for the presence of explosives, chemical weapons, biological weapons, illicit drugs, and the like. Vehicle inspection system 132 can inspect the vehicle by either of the technologies described herein above in connection with explosive detection system 120, chemical substance detection system 122, or weapon detection system 124.

Vehicle inspection system 132 can include a weighing mechanism to weigh each vehicle, and to identify an unusual load carried by the vehicle. Vehicle inspection system 132 can identify a suspect vehicle, by comparing the color of the vehicle, the license number of the vehicle, and the like, with those stored in a database (not shown).

Facial expression acquisition system 134 is a system for identifying a person whose facial expression and behavior (e.g., stress, agitation) conveys an intention to perform a criminal act. For this purpose facial expression acquisition system 134 includes a plurality of video cameras (not shown).

Luggage inspection system 136 is a system for detecting explosive charges, such as plastic bomb, hand grenade, and the like, a weapon, such as a firearm, sharp edged object, and the like, chemical substances, such as chemical warfare agent, biological agent, illicit drugs, and the like, within an object carried by the person, such as luggage, handbag, suitcase, briefcase, and the like. Luggage inspection system 136 can be a hold baggage screening system (HBSS), which operates based on X-ray technology, or computer tomography (CT), in order to acquire an image of the contents of the baggage. The HBSS can acquire a three-dimensional image by inspecting the contents of the baggage from different angles.

Alternatively, luggage inspection system 136 can operate based on thermal neutron capture technique, gas chromatography technique, and the like, in order to detect explosives in the baggage. Luggage inspection system 136 can operate based on MMW technology, infrared technology, magnetic resonance imaging (MRI), and the like, in order to detect weapons within the baggage.

System 100 is located in a protected area, such as the land which serves an airport, shopping center, office building, hospital, academic institute, military base, government facility, and the like. Each of local expert systems 108, 110 and 112 is responsible for a different surveillance field of the protected area (e.g., different terminals of an airport). The data acquisition systems are associated with a respective one of local expert systems 108, 110 and 112.

It is noted that a system similar to system 100 can include a single expert system for one surveillance field of a protected area, and one or more data acquisition systems coupled with the single expert system. In this case, the expert system is directly coupled with the warning system.

Local expert system 108 can receive data from the data acquisition systems, respective of selected persons in the crowd (e.g., only persons taller than four feet, excluding security guards) or for every person or entity (e.g., animals, vehicles and other objects) on the premises. Local expert system 108 can utilize the data received from each data acquisition system at different logical levels to be applied to different algorithms. For example, local expert system 108 can employ the video images acquired by video surveillance system 116, both for tracking a suspected person, and for examining the behavior of a suspected person (e.g., determining the stress level of that person).

Human marking system 126 provides local expert system 108 personal identification data respective of each person entering the protected area. This personal identification data is later used by either of local expert systems 108, 110 or 112, or by supervising system 104, to locate or track a person who is determined to be a suspicious person, or deploy a warning signal respective of that person. Each data acquisition system is associated with a weight function (i.e., the certainty of detection results of some of data acquisition systems is greater than others).

Local expert system 108 correlates between the data acquired by one data acquisition system, and the data acquired by one or more other data acquisition systems, herein below referred to as “data fusion”. While performing data fusion, local expert system 108 applies the weight function respective of each of the data acquisition systems, to the preliminary probability level determined by the respective data acquisition system, to determine a weighed probability level for that person examined by a plurality of data acquisition systems. Local expert system 108 determines a local threat level for each of selected persons in the respective surveillance field, according to the weighed probability level for that person (e.g., by comparing the weighed probability level with a weighed function threshold, according to an algorithm).

Local expert system 108 produces a data file for each person in the crowd, and associates the data file with the respective personal identification data, with the current surveillance field in which the person is located, and with the threat related data and the marking related data, acquired by the data acquisition systems for that person in the current surveillance field. Local expert system 108 also associates the respective local threat level, the direction of movement of that person, and the traffic trend of that person, with the respective data file. Local expert systems 110 and 112, and supervising system 104 can employ the data file for example to physically identify the suspected person, locate him or her, or track him or her, or enable cooperation between local expert systems 108, 110 and 112 to perform these procedures.

Local expert system 108 sends the respective data file, including the respective local threat level, to supervising system 104. Local expert system 110 operates in a manner similar to that of local expert system 108. Thus, local expert system 110 also determines a local threat level for that person, associates that local threat level with the data file of that person, and sends that data file to supervising system 104.

Supervising system 104 determines a global threat level for that person in the respective surveillance field, by assessing the local threat levels received from local expert systems 108 and 110. The global threat level can be for example, equal to the sum of local threat levels of local expert systems 108 and 110. Supervising system 104, in turn sends a signal to warning system 106 to issue a warning signal for the security personnel to arrest the suspect. In this case system 100 operates as a centralized system (i.e., supervising system 104 manages the operation of all components of system 100).

The security personnel can communicate with supervising system 104 to obtain information regarding the current location of the suspect (e.g., by viewing a video playback). The video playback can be performed on a temporal basis, according to the ordinal number of a video camera, according to an event, and the like. Supervising system 104 also marks that person as a suspect and associates that mark with the specific data acquisition system which indicated a suspicious feature on that person.

Supervising system 104 also sends the data file respective of the suspected person, to local expert system 112 which is responsible for another surveillance field adjacent to that of local expert system 110, thereby performing a hand-over from one surveillance field to another. In this manner, local expert system 112 can commence tracking of the suspected person, as he or she enters the new surveillance field from the previous one, thereby assisting the security personnel to locate the suspect.

Local expert system 108 can operate a dedicated warning system (not shown) coupled therewith, after assessing the local threat level produced by local expert system 108. Furthermore, local expert system 108 can send the local threat level to local expert system 110. Thus, a system similar to system 100 operates as a distributed system in which all the features of the centralized system mentioned herein above (i.e., managing of system 100 by supervising system 104), such as hand-over, tracking, playback, issuance of a warning signal, and the like, are present. This is due to the fact that the local expert systems are arranged within the expert system network, in a predetermined topography. It is noted that while operating as a distributed system, there is no need for local expert systems 108, 110 and 112 to send unnecessary data continuously to supervising system 104, and the operation of local expert systems 108, 110 and 112 is independent of the operation of supervising system 104. Hence, a distributed system is more robust than a centralized one, the data traffic is less, and thus operates at a greater bandwidth. A distributed system is obtained by embedding the supervising system within any one of the local expert systems. Local expert system 108, 110 and 112 can communicate with supervising system 104, via an internet protocol (IP). It is further noted that system 100, except biometric system 130, does not require active cooperation of the persons or vehicles entering the protected area, in order to identify a suspected person, but the persons and the vehicles can be examined while in movement.

In case the surveillance field of local expert system 108 overlaps that of local expert system 110, supervising system 104 performs the hand-over by employing the video surveillance systems of each of local expert systems 108 and 110. In case the surveillance fields of local expert systems 108 and 110 are non-overlapping, supervising system 104 employs the personal identification data respective of the suspected person, as acquired by human marking system 122, to perform the hand-over procedure between the surveillance fields of local expert systems 108 and 110.

Local expert system 108 modifies the data file respective of that person, in local expert system 110 which is responsible for another surveillance field adjacent to that of local expert system 108. Local expert system 110 can later use the modified data file to modify the local threat level for that person, which was previously determined by local expert system 108.

Each data acquisition system is associated with a data acquisition system threshold. In case a data acquisition system determines that the preliminary probability level for a person exceeds the data acquisition system threshold, that data acquisition system produces a high local threat level for that person, and sends that local threat level to supervising system 104. In general, the local expert system transmits the local threat level every time that a local threat level is set or updated. Supervising system 104, then follows the same procedure as in the case of data fusion described herein above, to arrest the suspect (i.e., system 100 operates as a centralized system).

Alternatively, local expert system 108 can operate on behalf of supervising system 104, in which case local expert system 108 sends that data file to local expert system 110. Local expert system 110, can then determine a new local threat level value, by combining the local threat levels determines by each of local expert systems 108 and 110. Local expert system 110 can operate the dedicated warning system (not shown) associated therewith, in order to enable the security personnel to arrest the suspected person, in which case a system similar to system 100 operates as a distributed system.

The data fusion feature allows local expert system 108 to determine physical parameters respective of a suspected object, such as an explosive, metallic object, firearm, and the like. For example, by correlating between data acquired by different data acquisition systems, local expert system 108 can determine the size and the type of a firearm, and a more accurate location of that firearm relative to the body of the suspected person.

In order to perform data fusion procedure on different data acquisition systems, local expert system 108 performs a scaling procedure, in order to normalize the data acquired by different data acquisition systems, to compare those data and fuse those data together. Local expert system 108 performs the scaling procedure either on data acquisition systems of the same types, or of different types.

In case of data acquisition systems of the same type (e.g., video cameras of video surveillance system 116) local expert system 108 constructs a visual scene of a feature, according to images of that feature acquired by different video cameras from different viewing angles. This procedure allows local expert system 108 to construct a complete image of a feature, notwithstanding that feature being partially or completely obstructed from the view of some of the video cameras in a certain period of time (e.g., the face of a person which is obstructed by other objects or people in the crowd). In this manner, local expert system 108 produces a facial signature, based on partial visual data.

In case of data acquisition systems of different types, for example if weapon detection system 124 indicates that a person conceals a metallic object under the clothing, local expert system 108 verifies this indication by analyzing the video images of the body of that person, acquired by video surveillance system 116. In this manner, the certainty that local expert system 108 determines whether that person is a suspect or not, is increased.

Supervising system 104 can analyze the data file respective of a person, to determine the probability of the movement of that person between different surveillance fields, according to the residence time of that person in each surveillance field. Each of local expert systems 108, 110 and 112 repeats the data acquisition procedure for every person in the crowd, in different surveillance fields, by employing independent data acquisition systems respective of each of local expert systems 108, 110 and 112.

Each of local expert systems 108, 110 and 112 can generate fictitious data similar to actual data which each of data acquisition systems generates, even if the data acquisition systems are not actually present in a surveillance field. This feature allows each of local expert systems 108, 110 and 112 to simulate a crime scene for the purpose of training the security personnel for a human threatening situation.

Vehicle inspection system 132 can identify a suspect vehicle when the vehicle enters the parking lot of the protected area, and prevent the occupants of the vehicle to enter the protected area itself (e.g., a terminal of an airport). Each of document inspection system 118 and biometric system 130 acquires data from one person at any given moment in a surveillance field, while that person is in a stationary mode. Therefore, local expert system 108 receives accurate physical location data, and personal identification data respective of that person, together with the document inspection data and the biometric data received from document inspection system 118 and biometric system 130, respectively.

Luggage inspection system 136 provides luggage identification data for each inspected luggage. Local expert system 108 associates the luggage identification data with the data file respective of the owner of the luggage, thereby being able to physically locate that owner within the protected area, at any given time. Human prescreening system 114 identifies a suspect who intends to enter the protected area, thereby preventing that person to enter the protected area.

Local expert system 108 compares the images of a person acquired by video surveillance system 116 with a plurality of images of criminals stored in a data base, and determines whether the acquired image is substantially identical with one or more of the stored images. Local expert system 108 also determines whether a person is a suspect, according to the behavior and facial expression data received from facial expression acquisition system 134. The quantity of the video cameras of video surveillance system 116 is determined according to the need to obtain a visual coverage of a given surveillance field. The video cameras can either provide a continuous image, or be triggered at selected intervals, in synchrony with other data acquisition systems in a given surveillance field.

In case the preliminary probability level of video surveillance system 116 is equal to or greater than the data acquisition system threshold of video surveillance system 116, local expert system 108 stores the images of the suspected person. The video cameras of video surveillance system 116 can be deployed in a given surveillance field by plug-and-play method.

Local expert system 108 can determine whether a person has made contact with a luggage, or lost contact with a luggage. Local expert system 108 constructs a complete characteristic vector for each person, in order to determine the path which that person follows, thereby classifying him or her as a suspected person. A system similar to system 100 can include a plurality of acousto-electric transducers (i.e., microphones), in order to enable local expert system 108 record voices and sounds.

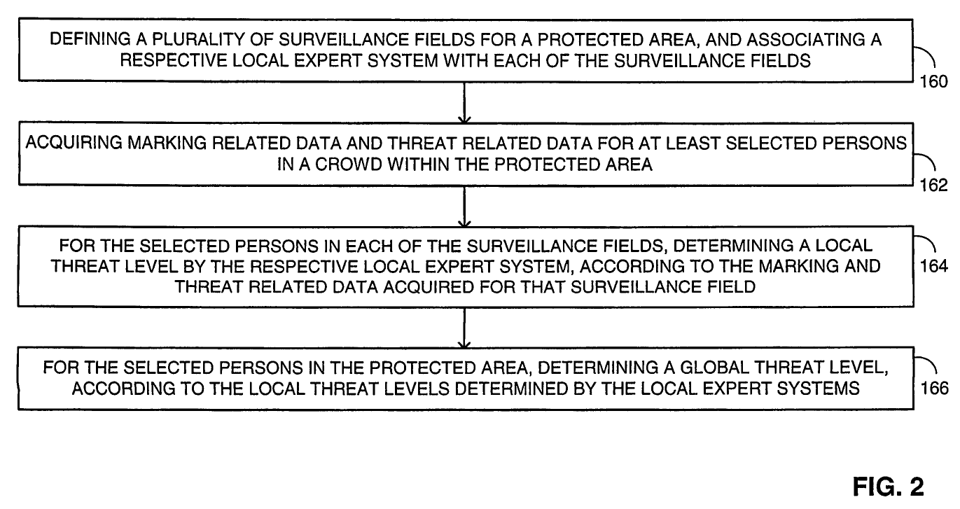

Reference is now made to FIG. 2, which is a schematic illustration of a method for operating the system of FIG. 1A, operative in accordance with another embodiment of the disclosed technique. In procedure 160, a plurality of surveillance fields for a protected area are defined, and a respective local expert system is associated with each of the surveillance fields. With reference to FIG. 1A, for example in case of an airport, the terminals and the parking lots of the airport are defined as different surveillance fields, and each of local expert systems 108, 110 and 112 is associated with each terminal and parking lot.

In procedure 162, marking related data and threat related data are acquired for at least selected persons in a crowd within the protected area. With reference to FIG. 1B, human prescreening system 114 acquires marking related data from selected persons who are about to enter the airport area, and video surveillance system 116 acquires both marking related data and threat related data of selected persons who are in the airport area.

In procedure 164, a local threat level is determined for the selected persons in each of the surveillance fields, by the respective local expert system, according to the identification and threat related data acquired for that surveillance field. With reference to FIG. 1B, in case the preliminary probability level determined by video surveillance system 116 for a selected person, is greater than the data acquisition system threshold thereof, video surveillance system 116 determines a local threat level for that person. With reference to FIG. 1B, local expert system 108 determines a local threat level by assessing the preliminary probability levels of video surveillance system 116 and weapon detection system 124.

In procedure 166, a global threat level is determined for the selected persons in the protected area, according to the local threat level determined by the local expert systems. With reference to FIG. 1A, supervising system 104 determines a global threat level for a selected person, according to the local threat levels determined by each of local expert systems 108, 110 and 112, for the selected person.

It will be appreciated by persons skilled in the art that the disclosed technique is not limited to what has been particularly shown and described hereinabove. Rather the scope of the disclosed technique is defined only by the claims, which follow.

1. System for identifying a threat associated person among a crowd in a protected area, the system comprising:
an expert system network, comprising a plurality of local expert systems, each of said local expert systems being associated with a respective one of a plurality of surveillance fields within said protected area, each said local expert systems being coupled with a plurality of data acquisition systems of various types, each of said data acquisition systems acquiring threat related data and marking related data respective of selected persons among said crowd within said respective surveillance field, each said local expert systems determining a respective local threat level for every one of said selected persons within said respective surveillance field, according to said threat related data and said marking related data; and
a supervising system coupled with said expert system network, said supervising system coordinating the operation of said local expert systems, said supervising system receiving from each of said local expert systems said respective local threat level, for every one of said selected persons within said respective surveillance field, said supervising system determining a global threat level according to said local threat levels, thereby identifying said threat associated person.

2. The system according to claim 1, further comprising a warning system coupled with said supervising system, said warning system producing a warning signal according to said global threat level.

3. The system according to claim 1, further comprising at least one warning system coupled with a respective one of said local expert systems, said at least one warning system producing a warning signal according to said respective local threat level.

4. The system according to claim 1, wherein said supervising system is embedded with at least one of said local expert systems.

5. The system according to claim 1, wherein at least one of said data acquisition systems determines a respective preliminary probability level respective of at least one of said selected persons, and
wherein said at least one data acquisition system determines a respective local threat level, according to at least one of said respective preliminary probability level and a data acquisition system threshold.

6. The system according to claim 1, wherein each of said local expert systems determines said respective local threat level, by correlating between data received from different ones of said data acquisition systems.

7. The system according to claim 1, wherein said protected area is selected from the list consisting of:
airport;
shopping center;
office building;
hospital;
academic institute;
military base; and
government facility.

8. The system according to claim 1, wherein each of said data acquisition systems is selected from the list consisting of:
human prescreening system;
video surveillance system;
document inspection system;
explosive detection system;
chemical substance detection system;
weapon detection system;
human marking system;
authorized personnel identification system;
biometric system;
vehicle inspection system;
facial expression acquisition system; and
luggage inspection system.

9. The system according to claim 1, further comprising a human marking system for marking each of said selected persons who enters at least one of said surveillance fields, by imaging at least one bodily feature of said selected person from a plurality of different viewing angles, by producing a three-dimensional signature of said bodily feature of said selected person, and by storing said three-dimensional signature.

10. The system according to claim 9, wherein said human marking system compares a newly produced three-dimensional signature with said stored three-dimensional signature, to track and identify said selected person.

11. The system according to claim 9, wherein said human marking system requires no cooperation from said selected persons, in order to operate.

12. Method for identifying a threat associated person among a crowd, the method comprising the procedure of:
acquiring marking related data and threat related data for at least selected persons in said crowd within a protected area;
determining a local threat level for said at least selected persons in each of a plurality of surveillance fields of said protected area, by a respective one of a plurality of local expert systems, according to threat related data and marking related data acquired for said surveillance field; and
determining a global threat level for said at least selected persons in said protected area, according to said local threat levels, determined by said local expert systems, thereby identifying said threat associated person.

13. The method according to claim 12, further comprising a preliminary procedure of defining said surveillance fields for said protected area.

14. The method according to claim 12, further comprising a preliminary procedure of associating said respective local expert system with a respective one of said surveillance fields.

15. The method according to claim 12, further comprising a preliminary procedure of embedding a supervising system which determines said global threat level, with at least one of said local expert systems.

16. The method according to claim 12, further comprising a procedure of producing a warning signal according to said local threat level.

17. The method according to claim 12, further comprising a procedure of producing a warning signal according to said global threat level.

18. The method according to claim 12, wherein said procedure of determining said local threat level is performed according to at least one of a preliminary probability level as determined by a respective data acquisition system, and a data acquisition system threshold respective of said respective data acquisition system.

19. The method according to claim 12, wherein said procedure of determining said local threat level is performed by correlating between said threat related data and said marking related data.

20. The method according to claim 12, wherein said procedure of determining said local threat level is performed according to data acquired by different types of data acquisition systems.

21. The method according to claim 12, further comprising a procedure of determining the location of said threat associated person within said protected area.

22. The method according to claim 12, further comprising a preliminary procedure of marking said at least selected persons at an entrance to said protected area.

23. The method according to claim 12, wherein said procedure of acquiring said marking related data is performed by imaging at least one bodily feature of said at least selected persons, from a plurality of different viewing angles, producing a three-dimensional signature of said at least one bodily feature and storing said three-dimensional signature.

24. The method according to claim 23, further comprising a procedure of tracking and identifying a selected person for whom newly acquired three-dimensional signature is produced in at least one of said surveillance fields, by comparing said newly acquired three-dimensional signature with said stored three-dimensional signature.

25. The method according to claim 12, wherein said procedure of acquiring said marking related data is performed without requiring any cooperation from said at least selected persons.

26. System for identifying a threat associated person among a crowd in a protected area, according to claim 1 substantially as described hereinabove.

27. System for identifying a threat associated person among a crowd in a protected area, according to claim 1 substantially as illustrated in any of the drawings.

28. Method for identifying a threat associated person among a crowd according to claim 12 substantially as described hereinabove.

29. Method for identifying a threat associated person among a crowd, according to claim 12 substantially as illustrated in any of the drawings.
